(19) United States
(12) Patent Application Publication
(10) Pub. No.: US 2015/0231830 A1
(43) Pub. Date: Aug. 20, 2015

(54) DEVICE OF COLOR 3D PRINTING AND METHOD THEREOF

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN)

(72) Inventors: Shih-Kuang TSAI, Taipei (TW); Li YU, Shanghai (CN)

(21) Appl. No.: 14/605,290

(22) Filed: Jan. 26, 2015

(30) Foreign Application Priority Data
Feb. 17, 2014 (CN) 201410053587.2

(51) Int. Cl. B29C 67/00

(52) U.S. Cl. CPC B29C 67/0088; B29C 67/0059; B33Y 10/00

(57) ABSTRACT

A device of color 3D printing and the method thereof are disclosed. The method is adapted to print a color 3D part. The device of color 3D printing at least has a print bed and a print head. The method includes the steps as follows. A solid model of the color 3D part is established, wherein the solid model at least consists of plural points and a color data for each thereof. A temperature/color table for a plastic material is then established. The table consists of plural heating temperatures for transforming the plastic material to specific colors respectively. The coordinates and color data of each point are obtained according to a predetermined sequence. The positions of the print bed and the print head are controlled according to obtained coordinates. The plastic material is heated according to the color data and the temperature/color table and is printed by the print head.

### CROSS REFERENCE TO RELATED APPLICATION

This application claims priority to China Patent Document No. 201410053587.2, filed on Feb. 17, 2014 with the China Patent Office, which is incorporated by reference in its entirety.

### BACKGROUND OF THE INVENTION

1. Field of the Invention

The present invention relates to a device of 3D printing and method thereof, and more particularly, to a device of color 3D printing and method thereof.

2. Description of the Prior Art

With development of technology and evolution of manufacturing, many manufacturing processes and the accuracy of work pieces are constantly improved. The traditional cutting, casting and other techniques have been unable to completely meet the requirement for every work piece when manufacturing, particularly for the work piece which has a special shape or a hole inside. However, the development of 3D printing probably allows the problem of manufacturing mentioned above to be solved. The 3D printing technology can provide not only rapid model molding, but also finished or semi-finished product with enough accuracy directly for some work pieces.

Actually, 3D printing has been used for years. Selective Laser Sintering (SLS), Three Dimensional Printing (3DP), Laminated Object Manufacturing (LOM), the current mainstream Fused Deposition Modeling (FDM), and the latest DLP technology have been developed successfully and performed in the manufacturing processes. The current 3D printing technology generates “ink” of the printing process through melting or softening plastic material, wherein the material is mainly composed of plastics, metals, or ceramics. However, most of work piece is composed of single material and single color. Although there are some printing techniques using multiple materials to perform the printing process, each material still has only one color. Therefore, the process of color 3D printing to create a color work piece becomes very complicated.

### SUMMARY OF THE INVENTION

The present invention provides a device of color 3D printing and method thereof, which allows a single material to have different color and then models a color 3D work piece.

According to some embodiments of the present invention, the present invention provides a device of color 3D printing for printing a color 3D part, comprising: a print bed, a print head, a supply module of thermosoluble material, a CAD/CAM module, and a control module. The print head at least comprises an extruding nozzle and a heating module. The supply module of thermosoluble material is connected to the print head for supplying the print head with a thermosoluble material, wherein the thermosoluble material has different colors at different temperatures. The CAD/CAM module is used to establish a solid model of the color 3D part, the solid model comprises a plurality of points and a color data corresponding to each point. The control module is connected to the print bed, the print head and the CAD/CAM module. The control module has a temperature/color table for reading coordinates and corresponding color data of a point selected from the plurality of points from the CAD/CAM module according to a predetermined sequence. And then the control module controls the positions of the print bed and the print head according to the coordinates of the point, controls the heating module to heat the thermosoluble material according to the color data and the temperature/color table, and prints the thermosoluble material through the extruding nozzle.

According to some embodiments of the present invention, the predetermined sequence is set in the CAD/CAM module and comprises a first sequence, a second sequence and a third sequence, the first sequence is a sequence for dividing the solid model into a plurality of layers along a first axial direction. The second sequence is a sequence for dividing each layer into a plurality of lines along a second axial direction. And the third sequence is a sequence for dividing each line into a plurality of points along a third axial direction. The temperature/color table is used to record heating temperatures corresponding to different colors for the thermosoluble material.

According to some embodiments of the present invention, the temperature/color table is used to record heating temperatures and heating time corresponding to different colors for the thermosoluble material. The control module is used to control the heating temperature and the heating time of the heating module to heat the thermosoluble material according to the color data and the temperature/color table.

According to some embodiments of the present invention, the thermosoluble material is thread-like in the supply module of thermosoluble material. The print head further comprises an extruding module for receiving the thread-like thermosoluble material from the supply module of thermosoluble material and applying an extruding force to the heating module and the extruding nozzle of the print head.

According to some embodiments of the present invention, the print bed is moving along the first axial direction, and the print head is moving along the second axial direction and the third axial direction. The thermosoluble material is a thermoplastic material with irreversible color.

According to some embodiments of the present invention, the present invention provides a method of color 3D printing, applied in a device of color 3D printing for printing a color 3D part. The device of color 3D printing comprises a print bed and a print head. The method of color 3D printing comprises the following steps of: establishing a solid model of the color 3D part, wherein the solid model comprises a plurality of points and a color data corresponding to each point; establishing a temperature/color table for recording heating temperatures corresponding to different colors for a thermosoluble material; reading coordinates and corresponding color data of a point selected from the plurality of points according to a predetermined sequence; controlling the positions of the print bed and the print head according to the coordinates of the point; heating the thermosoluble material according to the color data and the temperature/color table; and printing the thermosoluble material through the print head.

Through the device and method mentioned above, the present invention can print a color 3D part through using single material and controlling the heating temperature before modeling to change the color of the material.

The advantage and spirit of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows the sectional view of the print head of the device of color 3D printing according to an embodiment of the present invention.

FIG. 2 shows the 3D diagram of the device of color 3D printing according to an embodiment of the present invention.

FIG. 3 shows the block diagram of the device of color 3D printing according to an embodiment of the present invention.

FIG. 4 shows the flow chart of the method of color 3D printing according to an embodiment of the present invention.

### DETAILED DESCRIPTION OF THE INVENTION

A detailed description of the hereinafter described embodiments of the disclosed device and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

Take Fused Deposition Modeling (FDM) as an example, a solid model of a color 3D part will be established before modeling generally. For example, the solid model of the color 3D part will be established in the CAD/CAM module. And the solid model will be divided into a plurality of thin layers. For example, the solid model is divided into a plurality of thin layers along a first axial (such as Z axial) direction. And then the 2D geometric information will be generated to control the moving path of the print head. For example, each layer along a second axial (such as X axial) direction is divided into a plurality of lines (perpendicular to X axial). And then each line is divided into a plurality of points along a third axial (such as Y axial) direction. The points on the third axial (such as Y axial) of each line can be arranged according to a predetermined sequence, for example, from the maximum of Y to the minimum of Y. Therefore, the 2D moving path of the print head can be formed. The print head heats the thermosoluble material (such as Acrylonitrile Butadiene Styrene, Nylon, Waxes) to a critical state, which causes the material to be presented in a semi-fluid state. In the control module, the print head prints the thermosoluble material in the semi-fluid state along the moving path of determined 2D geometric information. And the material will solidify to form thin layer of shape and contour. Upon the first thin layer is completed, the vertical translation system controls the print bed to form a new layer and solidify the new layer. A solid 3D part is modeled bottom-up through layer by layer.

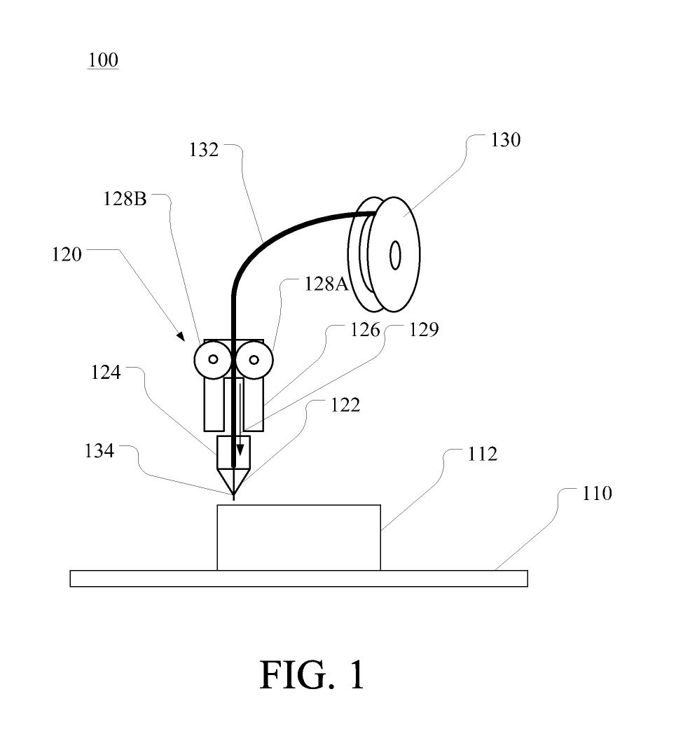

Please refer to FIG. 1. FIG. 1 shows the sectional view of the print head of the device of color 3D printing according to an embodiment of the present invention. In some embodiments of the present invention, a device of color 3D printing 100 mainly comprises a print bed 110, a print head 120, and a supply module of thermosoluble material 130. The print bed 110 is used to load a color 3D part 112 which is ready to be modeled. The print bed 110 can be moved up and down according to the demand. The print head 120 further comprises an extruding nozzle 122, a heating module 124, and an extruding module 126. The supply module of thermosoluble material 130 is used to supply a thermosoluble material 132, such as a thread-like thermosoluble material. In some embodiments of the present invention, the supply module of thermosoluble material 130 of the device of color 3D printing supplies the thread-like thermosoluble material 132 to the print head 120. The extruding module 126 of the print head 120, for example, can supply an extruding force 129 to the thread-like thermosoluble material 132 through two rollers 128A and 128B, which can accurately control the extruded volume of the thread-like thermosoluble material 132. The heating module 124 will heat the thread-like thermosoluble material 132 from the extruding module 126 to a determined temperature according to the command of control module (not shown in the FIG. 1). Upon the thread-like thermosoluble material 132 from the extruding module 126 is heated to the determined temperature and then continues to be heated for a determined time, the color of the thread-like thermosoluble material 132 can be changed. After the color of the thread-like thermosoluble material 132 is changed, the thread-like thermosoluble material 134 in demanding scale will be extruded out through the extruding nozzle 122. The scale of the thermosoluble material 134 is smaller than the scale of the thermosoluble material 132 for enhancing the resolution of the 3D printing. And the print head 120 will move to a predetermined position horizontally and extrude the thermosoluble material in demanding color according to the command of the control module.

In some embodiments of the present invention, the thread-like thermosoluble material 132 mentioned above is a thermoplastic material with irreversible color, which means the color can be changed according to the different heating temperature and/or time and the color is irreversible. For example, the thermoplastic material with irreversible color can be a temperature showing plastic with irreversible and changeable color (model number: SW-M-1) generated by SHIJIAZHANG NALUN HUAGONG KEJI CO., LTD. The precision is smaller than thirty micrometer and the color corresponded to the temperature is shown as following: the original color is deep green, 400 is deep green red, 450 is brick red, 500° C. is purple, 550° C. is light gray green, and 600° C. is light green. The color changing error is ±20° C. The constant temperature time is about ten minutes. This type of plastic can present different color according to different heating temperature, so this type of plastic can be used to model color 3D part. However, the thermosoluble material of the present invention is not limited to the material mentioned above. Any other material with similar properties can be used in the present invention, more specifically, with the constant temperature time is short and the temperature difference for changing color is small. The person who well knows the art in this field should know that the constituents of the print head of the present invention are not limited to the method mentioned above. The 3D printing method also is not limited to Fused Deposition Modeling (FDM). Any other 3D printing method which can control the melting temperature is comprised in the present invention, for example, Selective Laser Sintering (SLS), or electron beam melting modeling. And the device of color 3D printing and method thereof of the present invention will be further explained as following statement.

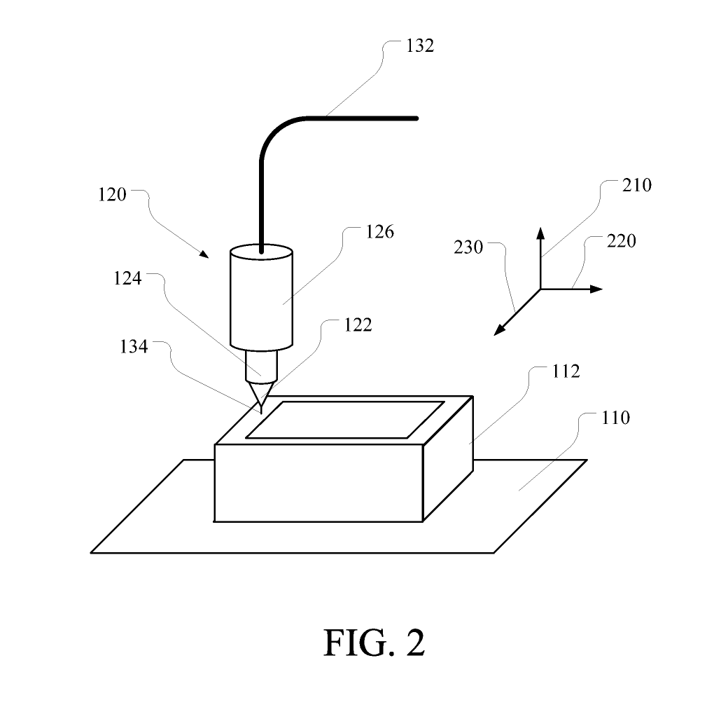

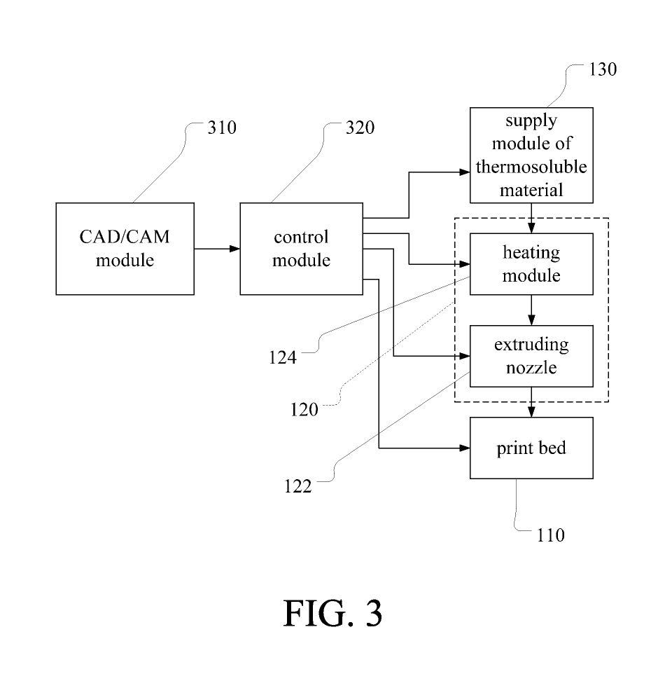

Please refer to FIG. 2 and FIG. 3. FIG. 2 shows the 3D diagram of the device of color 3D printing according to an embodiment of the present invention. FIG. 3 shows the block diagram of the device of color 3D printing according to an embodiment of the present invention. In some embodiments of the present invention, the device of color 3D printing and method thereof of the present invention use the CAD/CAM module 310 (shown in FIG. 3) to establish a solid model of the color 3D part. For example, the present invention can use CAD/CAM software, such as Pro/E, SolidWorks, Unigraphics, or AutoCAD, to establish a solid model of the color 3D part. The present invention can also use other methods, such as Laser scanning, or Computer tomography, to acquire the data in cloud and then establish a corresponded solid model of the color 3D part. Worth to noting that for the solid model of the color 3D part which is ready to be printed of the present invention, the present invention records not only corresponding geometric data, but also color data corresponding to each point of the solid model.

And then the present invention will use the CAD/CAM module 310 (shown in FIG. 3) to perform the discretization of the solid model. Because the solid model usually has some irregular free surface, the model has to be performed an approximate process before manufacturing. For example, curve line cannot be manufactured completely. The curve line has to be approximately divided into many parts of short straight line for modeling when manufacturing, which allows the subsequent data processing work become more conveniently. Because STL file format is simple and practical, the STL file format has become a major file format which is used most frequently to connect to a printing device. Complex model is approximately simulated by series of micro triangle planes. Every micro triangle is described by three vertex coordinates and a normal vector. The size of the triangle decides the accuracy of the simulation.

And then the present invention will use the CAD/CAM module 310 (shown in FIG. 3) to stratify the solid model: the applicable printing direction has to be selected according to the characters of the solid model. For example, the part of bigger area should be put at the bottom. And the present invention uses a series of plane with fixed interval to divide the discrete solid model into a plurality of layers along a first axial direction 210 (such as the height direction, Z) for requiring the profile information of the plane. The interval can be as small as submillimeter level. The accuracy of the printing gets higher if the interval gets smaller, but the printing time will also get longer. And then the 2D geometric information which is used to control the moving path of the print head 120 is generated. For example, each layer along a second axial (such as X axial) direction 220 is divided into a plurality of lines (perpendicular to X axial). And then each line is divided into a plurality of points along a third axial (such as Y axial) direction 230. The points of each line on the third axial 230 (such as Y axial) can be arranged according to a predetermined sequence, for example, from the maximum of Y to the minimum of Y. Therefore, the 2D moving path of the print head 120 can be formed. Each layer along the first axial direction 210 mentioned above can form the first sequence, for example, from the bottom to the top. Each line along a second axial direction 220 can form the second sequence, for example, from the minimum of X to the maximum of X. Each point along the third axial direction 230 can form the third sequence, for example, from the maximum of Y to the minimum of Y. From each point of the third sequence, each line can be formed in sequence. Each line can be connected by the second sequence to form the shape of each plane. Each plane can be connected by the first sequence to form the solid model of the color 3D part.

As shown in FIG. 3, the control module 320 can require coordinates and corresponding color data of each point from the CAD/CAM module according to a predetermined sequence, which is the third sequence, the second sequence, and the first sequence, to control the supply module of thermosoluble material 130, print head 120, and print bed 110 to perform the color 3D printing. According to the applied thermosoluble material, the control module 320 establishes a temperature/color table for recording heating temperatures and heating time corresponding to different colors for the thermosoluble material. The control module 320 controls the supply module of thermosoluble material 130 to supply applicable thermosoluble material 132 (FIG. 2) to the print head 120. The control module 320 also controls the print head 120 to move along the second axial (X-axial) direction and the third axial (Y-axial) direction, and controls the print bed 110 to move along the first axial (Z-axial) direction. And according to the color data and the temperature/color table, the control module 320 controls the heating temperature of the heating module 124 to heat the thermosoluble material 132, controls the heating time through the heating module 124 and the extruding nozzle 122 to allow the thermosoluble material 132 to achieve the demanding color, and controls the extruding nozzle 122 to print the thermosoluble material on the corresponding position. The printed points in sequence will constitute lines, and the lines will constitute planes. Finally, the shape of the planes is formed in sequence and then the color 3D part is completed through superimposing the planes.

However, the person who well knows the art in this field should know that the printing method and sequence mentioned above is only one embodiment of the present invention. The present invention is not limited by the statement mentioned above. Any other type of printing sequence should be comprised in the spirit of the present invention. For example, the printing sequence of each plane can be printing the points with same color in turn. For example, printing the points with red color, and then printing the points with green color, finally printing the points with yellow color. Additionally, the method of the control module controls the printing position is not limited to the statement mentioned above. The print bed can be controlled to move along X-axial and Y-axial direction, and the print head can be controlled to move along Z-axial direction. The method of the control module controls the printing position can be adjusted according to the design of the printing device.

Additionally, the present invention is not limited to have only one print head. The present invention can comprise many print heads to print different thermosoluble materials for forming different colors. And the present invention is not limited to have only one supply module of thermosoluble material. The present invention can comprise many supply modules of thermosoluble material to supply many basic colors of thermosoluble material. The print head can not only print the color 3D part, but also print support member for supporting the plane according to some demands of the plane, which can enhance the stability when superimposing the planes of printing.

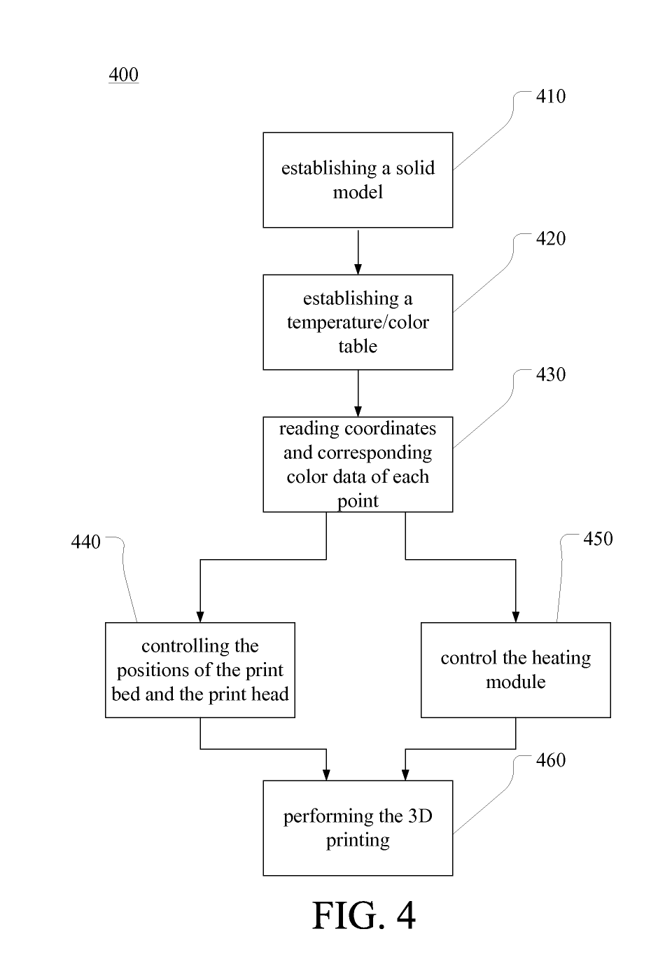

Please refer to FIG. 4. FIG. 4 shows the flow chart 400 of the method of color 3D printing according to an embodiment of the present invention. Conclude the statement mentioned above, the method of color 3D printing of the present invention comprises the following steps of: (S410) establishing a solid model of the color 3D part, wherein the solid model comprises a plurality of points and a color data corresponding each point. (S420) establishing a temperature/color table for recording heating temperatures and/or heating time corresponding to different colors for a thermosoluble material according to the applied thermosoluble material. (S430) reading coordinates and corresponding color data of each point according to a predetermined sequence (such as the third sequence, the second sequence, and the first sequence). (S440) controlling the positions of the print bed and the print head according to the coordinates of the point. (S450) heating the thermosoluble material (through the heating module) according to the color data and the temperature/color table. (S460) upon the thermosoluble material achieving the demanding color, printing the thermosoluble material through the print head for performing the 3D printing.

According to the device and method of the present invention, the present invention can use single material to print out a color 3D part through controlling the heating temperature and/or heating time before modeling to change the color of the material.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A device of color 3D printing for printing a color 3D part, comprising:
a print bed;
a print head, at least comprising an extruding nozzle and a heating module;
a supply module of thermosoluble material, connected to the print head for supplying the print head with a thermosoluble material, wherein the thermosoluble material has different colors at different temperatures;
a CAD/CAM module, for establishing a solid model of the color 3D part, the solid model comprising a plurality of points and a color data corresponding to each point; and
a control module, connected to the print bed, the print head and the CAD/CAM module, the control module having a temperature/color table for reading coordinates and corresponding color data of a point selected from the plurality of points from the CAD/CAM module according to a predetermined sequence, controlling the positions of the print bed and the print head according to the coordinates of the point, controlling the heating module to heat the thermosoluble material according to the color data and the temperature/color table, and printing the thermosoluble material through the extruding nozzle.

2. The device of claim 1, wherein the predetermined sequence is set in the CAD/CAM module and comprises a first sequence, a second sequence and a third sequence, the first sequence is a sequence for dividing the solid model into a plurality of layers along a first axial direction, the second sequence is a sequence for dividing each layer into a plurality of lines along a second axial direction, and the third sequence is a sequence for dividing each line into a plurality of points along a third axial direction.

3. The device of claim 2, wherein the control module is used to control the print bed to move along the first axial direction, and control the print head to move along the second axial direction and the third axial direction.

4. The device of claim 1, wherein the temperature/color table is used to record heating temperatures corresponding to different colors for the thermosoluble material.

5. The device of claim 1, wherein the temperature/color table is used to record heating temperatures and heating time corresponding to different colors for the thermosoluble material.

6. The device of claim 5, wherein the control module is used to control the heating temperature and the heating time of the heating module to heat the thermosoluble material according to the color data and the temperature/color table.

7. The device of claim 1, wherein the thermosoluble material is thread-like in the supply module of thermosoluble material, the print head further comprises an extruding module for receiving the thread-like thermosoluble material from the supply module of thermosoluble material and applying an extruding force to the heating module and the extruding nozzle of the print head.

8. The device of claim 1, wherein the thermosoluble material is a thermoplastic material with irreversible color.

9. A method of color 3D printing, applied in a device of color 3D printing for printing a color 3D part, the device of color 3D printing comprising a print bed and a print head, the method of color 3D printing comprising the following steps of:
establishing a solid model of the color 3D part, the solid model comprising a plurality of points and a color data corresponding each point;
establishing a temperature/color table for recording heating temperatures corresponding to different colors for a thermosoluble material; and
reading coordinates and corresponding color data of a point selected from the plurality of points according to a predetermined sequence, controlling the positions of the print bed and the print head according to the coordinates of the point, heating the thermosoluble material according to the color data and the temperature/color table, and printing the thermosoluble material through the print head.

10. The method of claim 9, wherein the predetermined sequence comprises a first sequence, a second sequence and a third sequence, the first sequence is a sequence for dividing the solid model into a plurality of layers along a first axial direction, the second sequence is a sequence for dividing each layer into a plurality of lines along a second axial direction, and the third sequence is a sequence for dividing each line into a plurality of points along a third axial direction.

11. The method of claim 10, wherein the step of controlling the positions of the print bed and the print head according to the coordinates of the point is:
controlling the print bed to move along the first axial direction according to the coordinates of the point, and control the print head to move along the second axial direction and the third axial direction.

12. The method of claim 9, wherein the temperature/color table is used to record heating time corresponding to different colors for the thermosoluble material.

13. The method of claim 12, wherein the step of heating the thermosoluble material according to the color data and the temperature/color table is:
controlling the heating time of the thermosoluble material according to the color data and the temperature/color table.

14. The method of claim 9, wherein the thermosoluble material is a thermoplastic material with irreversible color.
